(19) United States
(12) Patent Application Publication
(10) Pub. No.: US 2024/0345305 A1
(43) Pub. Date: Oct. 17, 2024

(54) HEAD MOUNTED ELECTRONIC DEVICE

(71) Applicant: Innolux Corporation, Miaoli County (TW)

(72) Inventors: Jian-Min Leu, Miaoli County (TW); Chih-Lung Lin, Miaoli County (TW); Yung-Hsin Lu, Miaoli County (TW)

(73) Assignee: Innolux Corporation, Miaoli County (TW)

(21) Appl. No.: 18/597,944

(22) Filed: Mar. 7, 2024

(30) Foreign Application Priority Data
Apr. 12, 2023 (CN) 202310388361.7

(51) Int. Cl. G02B 5/30

(52) U.S. Cl. CPC G02B 5/3083

(57) ABSTRACT

A head mounted electronic device includes a dimming module. The dimming module has a normal direction. The dimming module has a first transmittance T1 in the normal direction and a second transmittance T2 in an oblique direction. An included angle between the oblique direction and the normal direction is 60 degrees. The head mounted electronic device satisfies: [(T1-T2)/T1]*100%<50%.

### CROSS-REFERENCE TO RELATED APPLICATION

This application claims the priority benefit of China application serial no. 202310388361.7, filed on Apr. 12, 2023. The entirety of the above-mentioned patent application is hereby incorporated by reference herein and made a part of this specification.

### BACKGROUND

### Technical Field

The disclosure relates to an electronic device, and in particular to a head mounted electronic device.

### Description of Related Art

The existing head mounted electronic device improves the clarity of a virtual image by reducing the ambient light intensity in the virtual image area through a dimming module. However, obliquely incident ambient light and normally incident ambient light have different phase retardation after passing through the dimming module, resulting in difference in transmittance of the dimming module for obliquely incident ambient light and normally incident ambient light, which leads to poor viewing experience of a wearer.

### SUMMARY

The disclosure provides a head mounted electronic device, which facilitates the reduction in difference in transmittance of ambient light with different incident angles.

In an embodiment of the disclosure, the head mounted electronic device includes a dimming module. The dimming module has a normal direction. The dimming module has a first transmittance T1 in the normal direction and a second transmittance T2 in an oblique direction. An included angle between the oblique direction and the normal direction is 60 degrees. The head mounted electronic device satisfies: [(T1-T2)/T1]*100%<50%.

In order to make the aforementioned features and advantages of the disclosure comprehensible, embodiments accompanied with drawings are described in detail as follows.

### BRIEF DESCRIPTION OF THE DRAWINGS

FIG. 1 is a schematic diagram of a head mounted electronic device according to some embodiments of the disclosure.

FIG. 2 is an enlarged view of a dimming module in FIG. 1.

FIGS. 3 to 7 are exploded schematic diagrams of various embodiments of the dimming module in FIG. 2, respectively.

### DESCRIPTION OF THE EMBODIMENTS

Reference is now made in detail to exemplary embodiments of the disclosure, and examples of the exemplary embodiments are illustrated in the accompanying drawings. If applicable, the same reference numerals in the drawings and the descriptions are used to indicate the same or similar parts.

Certain terms are used to refer to specific elements throughout the specification of the disclosure and the appended claims. Those of ordinary skill in the art should understand that electronic device manufacturers may refer to the same elements by different names. The following embodiments do not intend to distinguish between elements with the same function but different names. In the description and claims below, words such as “including” and “comprising” are open-ended words, so these words should be interpreted as the meaning of “including but not limited to . . . .”

In the following embodiments, wordings used to indicate directions, such as “up,” “down,” “front,” “back,” “left,” and “right,” merely refer to directions in the accompanying drawings. Therefore, the directional wordings are used to illustrate rather than limit the disclosure. In the accompanying drawings, the drawings illustrate the general features of the methods, structures, and/or materials used in the particular embodiments. However, the drawings shall not be interpreted as defining or limiting the scope or nature covered by the embodiments. For example, the relative size, thickness, and location of film layers, regions, and/or structures may be reduced or enlarged for clarity.

In the disclosure, a structure (or layer, element, substrate) is described as being on or above another structure (or layer, element, substrate), which may mean that the two structures are adjacent and directly connected, or may mean that the two structures are adjacent but not directly connected. Non-direct connection refers to the presence of at least one intermediate structure (or intermediate layer, intermediate element, intermediate substrate, intermediate spacer) between the two structures, with the lower surface of one structure adjacent or directly connected to the upper surface of the intermediate structure, and the upper surface of the other structure adjacent or directly connected to the lower surface of the intermediate structure. The intermediate structure may be composed of single or multiple layers of physical or non-physical structures, with no limitations. In the disclosure, when a structure is placed “on” another structure, such description may mean that the structure is “directly” on the another structure, or may mean that the structure is “indirectly” on the another structure, that is, at least one structure is sandwiched and disposed between the structure and the another structure.

The terms “approximately,” “equal to,” “equivalent” or “the same,” “substantially” or “roughly” are generally interpreted as within 20% of the given value or range, or interpreted as within 10%, 5%, 3%, 2%, 1%, or 0.5% of the given value or range. In addition, the wordings “a range from a first value to a second value” and “a range between a first value and a second value” indicate that the described range includes the first value, the second value, and other values therebetween.

The ordinal numbers used in the specification and claims, such as “first”, “second”, etc., are used to modify elements, and the ordinal numbers themselves neither imply and represent that the (or these) elements have any previous ordinal numbers nor represent the order of one element with another, or the order of manufacturing methods. The use of the ordinal numbers is merely used to clearly distinguish an element with a certain name from another element with the same name. The same terms may not be used in the claims and the specification. Therefore, a first component in the specification may be a second component in the claims.

In the disclosure, the electrical connection or coupling described may refer to either the direct connection or the indirect connection. In the case of the direct connection, the endpoints of the elements on two circuits are directly connected or interconnected by a conductor segment. In the case of the indirect connection, switches, diodes, capacitors, inductors, resistors, other suitable elements, or combinations thereof exist between the endpoints of the elements on the two circuits, but not limited thereto.

In the disclosure, the measurement methods of thickness, length, and width may be measured by using an optical microscope (OM), and thickness or width may be measured from cross-sectional images in an electron microscope, but not limited thereto. In addition, any two values or directions used for comparison may have a certain error. Furthermore, the terms “equal to,” “equivalent,” “the same,” “substantially,” or “approximately” mentioned in the disclosure generally represent within a 10% range of the given value or range. Moreover, the wordings “a given range from a first value to a second value,” “a given range falls within the range of a first value to a second value,” or “a given range is between a first value and a second value” indicate that the given range includes the first value, the second value, and other values therebetween. If a first direction is perpendicular to a second direction, the angle between the first direction and the second direction may be between 80 degrees and 100 degrees; if a first direction is parallel to a second direction, the angle between the first direction and the second direction may be between 0 degrees and 10 degrees.

It should be noted that in the following embodiments, without departing from the spirit of the disclosure, features in several different embodiments may be replaced, reorganized, and mixed to complete other embodiments. As long as the features of the various embodiments do not violate the spirit of the disclosure or conflict with each other, the various embodiments may be mixed and matched arbitrarily.

Unless otherwise defined, all terms used herein (including technical and scientific terms) have the same meaning as commonly understood by those of ordinary skill in the art of the disclosure. It can be understood that these terms, for example, as defined in commonly used dictionaries, should be interpreted as having meanings consistent with the relevant technology and the background or context of the disclosure, and should not be interpreted in an idealized or overly formal manner, unless specifically defined in the embodiments of the disclosure.

In the disclosure, the electronic device may include a display device, a backlight device, an antenna device, a sensing device, or a splicing device, but not limited thereto. The electronic device may be a bendable or flexible electronic device. The display device may be a non-self-illuminating display device or a self-illuminating display device. The electronic device may include, for example, liquid crystals, light-emitting diodes, fluorescence, phosphor, quantum dots (QD), other suitable display media, or combinations thereof. The antenna device may include, for example, a Frequency Selective Surface (FSS), a RF-Filter, a polarizer, a resonator, or an antenna, etc. The antenna may be a liquid crystal antenna or a non-liquid crystal antenna. The sensing device may be a sensing device for sensing capacitance, light, heat or ultrasonic, but not limited thereto. In the disclosure, the electronic device may include an electronic element, which may include passive elements and active elements, such as capacitors, resistors, inductors, diodes, transistors, etc. Diodes may include light-emitting diodes or photodiodes. Light-emitting diodes may include, for example, organic light emitting diodes (OLEDs), mini LEDs, micro LEDs, or quantum dot LEDs, but not limited thereto. The splicing device may be, for example, a display splicing device or an antenna splicing device, but not limited thereto. It should be noted that the electronic device may be any permutation and combination of the aforementioned, but not limited thereto. In addition, the shape of the electronic device may be rectangular, circular, polygonal, curved-edged, or other suitable shapes. The electronic device may have peripheral systems such as a drive system, a control system, a light source system, etc., to support the display device, the antenna device, the wearable device (e.g., including glasses configured for augmented reality or virtual reality), the vehicle mounted device (e.g., including automotive windshields), or the splicing device.

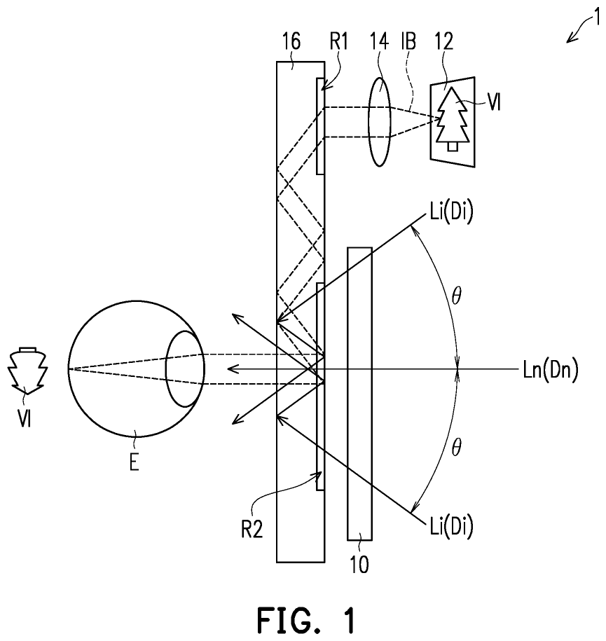

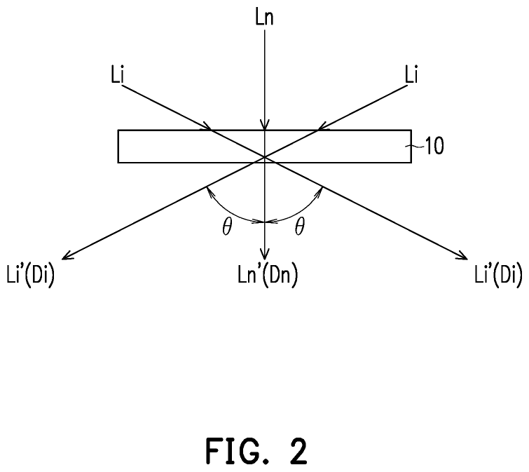

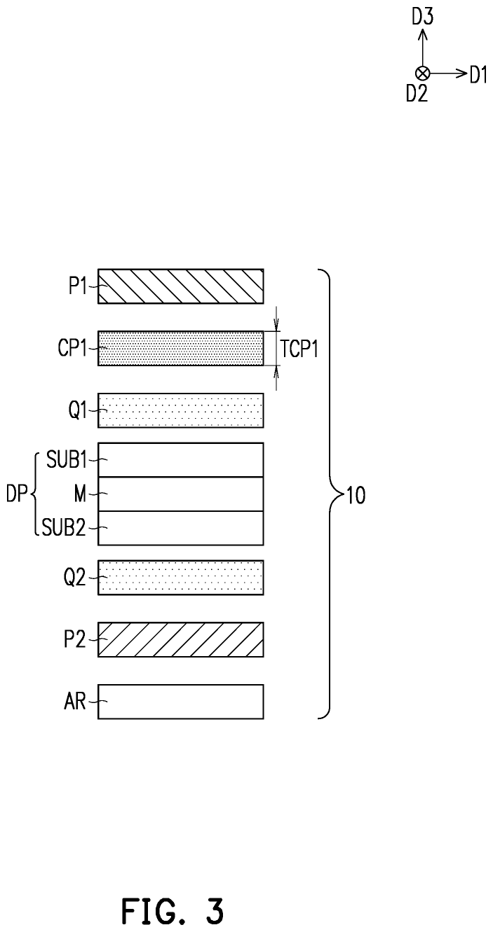

FIG. 1 is a schematic diagram of a head mounted electronic device according to some embodiments of the disclosure. FIG. 2 is an enlarged view of a dimming module in FIG. 1. FIGS. 3 to 7 are exploded schematic diagrams of various embodiments of the dimming module in FIG. 2, respectively.

Referring to FIGS. 1 and 2, a head mounted electronic device 1 includes a dimming module 10. The dimming module 10 has a normal direction Dn. The dimming module 10 has a first transmittance T1 in the normal direction Dn and a second transmittance T2 in an oblique direction Di. An included angle θ between the oblique direction Di and the normal direction Dn is 60 degrees. The head mounted electronic device 1 satisfies: [|(T1-T2)|/T1]*100%<50%. The head mounted electronic device of the disclosure may also be, for example, smart glasses, which may be configured for augmented reality, but the disclosure is not limited thereto.

The normal direction Dn of the dimming module 10 is the direction perpendicular to the dimming module 10. A light ray (such as ambient light) Ln normally incident on the dimming module 10 is parallel to the normal direction Dn of the dimming module 10, and the included angle θ between the light ray Ln normally incident on the dimming module 10 and a light ray (such as ambient light) Li incident on the dimming module 10 in the oblique direction Di is 60 degrees.

The transmittance is defined as the percentage of (the light intensity of the light ray that does not pass through the dimming module 10—the light intensity of the light ray that passes through the dimming module 10)/the light intensity of the light ray that does not pass through the dimming module 10. Taking the light ray Ln normally incident on the dimming module 10 as an example, the first transmittance T1 is equal to the percentage of (a light intensity In of the light ray Ln that does not pass through the dimming module 10—a light intensity In' of a light ray Ln' that passes through the dimming module 10)/the light intensity In of the light ray Ln that does not pass through the dimming module 10, that is, T1=[(In-In')/In]*100%. Taking the light ray Li incident on the dimming module 10 in the oblique direction Di as an example, the second transmittance T2 is equal to the percentage of (a light intensity Ii of the light ray Li that does not pass through the dimming module 10—a light intensity Ii' of a light ray Li' that passes through the dimming module 10)/the light intensity Ii of the light ray Li that does not pass through the dimming module 10, that is, T2=[(Ii-Ii')/Ii]*100%. In addition, [(T1-T2)/T1]*100%<50% indicates that the difference between the first transmittance T1 and the second transmittance T2 divided by the first transmittance T1 is less than 50%. The aforementioned “light intensity” refers to the spectral integral value of the light source (which may be, for example, ambient light). In some embodiments, the light source may include visible light (e.g., wavelengths between 380 nm and 780 nm) or ultraviolet light (e.g., wavelengths less than 365 nm), but is not limited thereto, that is, when the light source is visible light, the light intensity is the spectral integral value in the range of wavelengths 380 nm to 780 nm.

According to different requirements, the head mounted electronic device 1 may further include other elements or film layers. For example, the head mounted electronic device 1 may further include a display 12, a lens set 14, and a waveguide 16 to provide the application requirements of augmented reality (AR), but not limited thereto.

The dimming module 10, the display 12, and the lens set 14, for example, are jointly disposed on a side of the waveguide 16 away from an eye E of the wearer. The display 12 is disposed corresponding to a light input area R1 of the waveguide 16, the lens set 14 is disposed between the light input area R1 of the waveguide 16 and the display 12, and the dimming module 10 is disposed corresponding to a light output area R2 of the waveguide 16.

The display 12 is configured to provide a virtual image VI. For example, the display 12 may be a micro display, such as a micro light emitting diode display, a micro organic light emitting diode display, or a liquid crystal on silicon (LCoS) display, but is not limited thereto.

Image light IB from the display 12 may be concentrated to the light input area R1 of the waveguide 16 through the lens set 14. The lens set 14 may include one or more lenses, which is not further limited here.

The image light IB entering the waveguide 16 may be transmitted in the waveguide 16 by the method of total internal reflection (TIR). For example, the material of the waveguide 16 may include glass, plastic, ceramic, quartz, sapphire, or a combination thereof, but not limited thereto.

The light input area R1 of the waveguide 16 may have multiple light guide structures (not shown) that transmit the image light IB entering the waveguide 16 towards the light output area R2 of the waveguide 16. The light output area R2 of the waveguide 16 may have multiple light guide structures (not shown) that transmit the image light IB transmitted in the waveguide 16 towards the eye E of a user.

The dimming module 10 disposed corresponding to the light output area R2 of the waveguide 16 may be a transparent dimming panel and may serve as alight switch. By regionally controlling the transmittance of the dimming module 10, such as making the transmittance of the virtual image area lower than the transmittance of other areas (areas outside the virtual image), the clarity of the virtual image VI seen by the wearer may be improved. For the high-transmittance area (the area in the bright state), the dimming module 10 may be designed to allow the light ray Ln (e.g., ambient light) normally/vertically incident on the dimming module 10 and the light ray Li (e.g., ambient light) obliquely incident on the dimming module 10 to pass through. By reducing the difference in transmittance of ambient light with different incident angles (such as the light ray Ln and the light ray Li) in the bright state, for example, satisfying [(T1-T2)/T1]*100%<50%, such a way facilitates the enhancement of the viewing experience of the wearer of the head mounted electronic device 1.

Please refer to the descriptions of FIGS. 3 to 7 for the specific structure of the dimming module 10 and the method of reducing the transmittance of ambient light with different incident angles (such as the light ray Ln and the light ray Li).

In some embodiments, as shown in FIG. 3, the dimming module 10 may include a first polarizing film P1, a second polarizing film P2, a panel DP disposed between the first polarizing film P1 and the second polarizing film P2, and a first compensation film CP1 disposed between the first polarizing film P1 and the panel DP, but not limited thereto. The dimming module 10 may add other film layers according to different needs.

The first polarizing film P1 and the second polarizing film P2 are disposed relative to each other, and the first polarizing film P1 and the second polarizing film P2 may have mutually perpendicular transmission axes, that is, the included angle between the transmission axis of the first polarizing film P1 and the transmission axis of the second polarizing film P2 is 90 degrees. For example, the transmission axis of the first polarizing film P1 and the transmission axis of the second polarizing film P2 are both parallel to the plane formed by a direction D1 and a direction D2, and the transmission axis of the first polarizing film P1 and the transmission axis of the second polarizing film P2 may be parallel to the direction D2 and the direction D1, respectively, but not limited thereto.

The panel DP may be a translucent liquid crystal panel and may include an upper substrate SUB1, a lower substrate SUB2, and a dielectric layer M (such as a liquid crystal layer) disposed between the upper substrate SUB1 and the lower substrate SUB2. In some embodiments, although not shown, the panel DP may further include two conductive layers, which are electrically insulated from each other and may be respectively disposed between the upper substrate SUB1 and the dielectric layer M, and between the lower substrate SUB2 and the dielectric layer M, or jointly disposed on a side of the dielectric layer M (for example, stacked between the lower substrate SUB2 and the dielectric layer M). In other embodiments, the upper substrate SUB1 and the lower substrate SUB2 themselves may be conductive, and the panel DP may not include two conductive layers. In some embodiments, the panel DP, for example, exhibits a bright state when no bias is applied. The dimming effect may be achieved by adjusting the state of the dielectric layer M (such as the tilt direction of the liquid crystal) through controlling the potential difference between the two conductive layers. Although not shown, the panel DP may include multiple dimming units (such as multiple pixels). The dimming units may be arranged in an array, allowing independent dimming of different areas of the panel DP to be performed.

The first compensation film CP1 may compensate for the phase retardation of the thickness (Rth) of the light ray (such as ambient light) obliquely incident on the dimming module 10, which facilitates the reduction in the differences in phase retardation of light rays with different incident angles after passing through the dimming module 10, and allows the dimming module 10 to have similar transmittance for oblique ambient light and normal ambient light, thereby improving the viewing experience of the wearer.

Rth=(Nz-Nx)*d, where Nz and Nx are the refractive indices of the compensation film in a direction D3 and the direction D1, respectively, and d is the thickness of the compensation film. Phase delay measurement systems such as Rets may be used to measure the Rth of the compensation film. In addition, the Rth of the first compensation film CP1 may be adjusted and changed by material selection or thickness (such as a thickness TCP1) control, thereby reducing the difference in transmittance and improving the viewing experience of the wearer.

In some embodiments, the Rth of the first compensation film CP1 is between 125 nm and 250 nm, that is, 125 nm≤Rth≤250 nm, but not limited thereto. In some embodiments, the first compensation film CP1 may be a C-type compensation film. A refractive index (N) of the C-type compensation film satisfies Nx=Ny≠Nz. Nx, Ny, and Nz are the refractive indices in the direction D1, the direction D2, and the direction D3, respectively. Specifically, Nx is, for example, the refractive index measured along the direction D1, Ny is, for example, the refractive index measured along the direction D2, and Nz is, for example, the refractive index measured along the direction D3. In some embodiments, the direction D3 is the thickness direction of the compensation film, the direction D1 and the direction D2 are perpendicular to the direction D3, and the direction D1 is perpendicular to the direction D2. Nx, Ny, and Nz in the embodiments may be defined as described above, so the descriptions are not repeated here. The first compensation film CP1 may be a single-layer film or a multi-layer film. For example, the first compensation film CP1 may be a single-layer C-type compensation film or a multi-layer C-type compensation film, but not limited thereto. The direction D3 may be substantially parallel to the normal direction Dn of the dimming module 10.

In some embodiments, the dimming module 10 may further include a quarter-wave plate Q1 disposed between the first compensation film CP1 and the panel DP, and a quarter-wave plate Q2 disposed between the panel DP and the second polarizing film P2, to enhance the dark state contrast. In addition, the quarter-wave plate Q1 and the quarter-wave plate Q2 may have mutually perpendicular optical axes, that is, the included angle between the optical axis of the quarter-wave plate Q1 and the optical axis of the quarter-wave plate Q2 is 90 degrees. For example, the optical axis of the quarter-wave plate Q1 and the optical axis of the quarter-wave plate Q2 may both be parallel to the plane formed by the direction D1 and the direction D2. The included angle between the optical axis of the quarter-wave plate Q1 and the direction D1 may be 225 degrees, and the included angle between the optical axis of the quarter-wave plate Q2 and the direction D1 may be 135 degrees, but not limited thereto. In other embodiments, although not shown, the dimming module 10 may omit the quarter-wave plate Q1 and the quarter-wave plate Q2.

In some embodiments, the dimming module 10 may further include an anti-reflection film AR, and the second polarizing film P2 may be, for example, disposed between the anti-reflection film AR and the quarter-wave plate Q2. In other embodiments, although not shown, the dimming module 10 may omit the anti-reflection film AR.

In some embodiments, the first polarizing film P1 may be disposed near the waveguide 16 of FIG. 1, that is, the first polarizing film P1 may be located between the second polarizing film P2 and the waveguide 16, but not limited thereto. In other embodiments, the second polarizing film P2 or the anti-reflection film AR (if any) may be disposed near the waveguide 16 of FIG. 1, that is, the second polarizing film P2 or the anti-reflection film AR (if any) may be located between the first polarizing film P1 and the waveguide 16. The dimming modules of the following embodiments may be disposed relative to the waveguide 16 of FIG. 1 in the same manner as described above, and the descriptions are not repeated below.

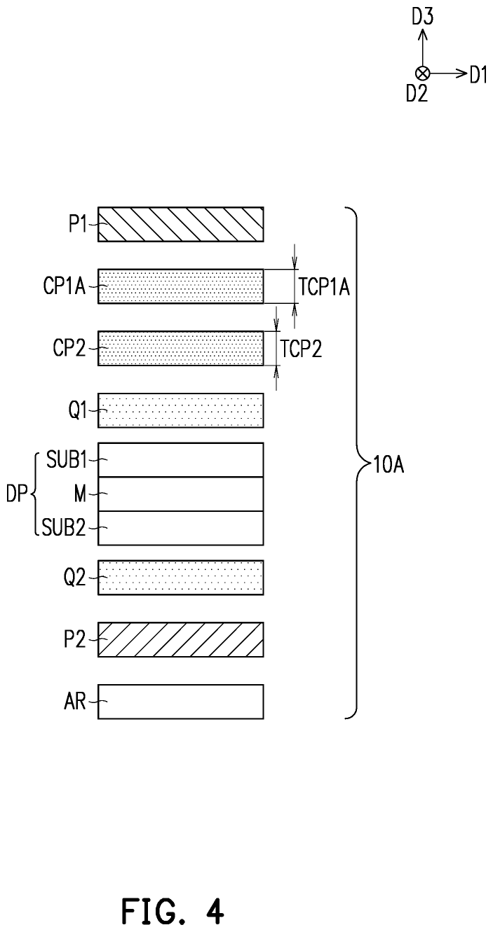

Referring to FIG. 4, the main differences between a dimming module 10A and the dimming module 10 of FIG. 3 are described as follows. In the dimming module 10A, a first compensation film CP1A is an A-type compensation film. The refractive index (N) of the A-type compensation film satisfies Nx≠Ny. In addition, the dimming module 10A further includes a second compensation film CP2 disposed between the first polarizing film P1 and the panel DP, and the first compensation film CP1A and the second compensation film CP2 have mutually perpendicular optical axes, that is, the included angle between the optical axis of the first compensation film CP1A and the optical axis of the second compensation film CP2 is 90 degrees. For example, the optical axis of the first compensation film CP1A and the optical axis of the second compensation film CP2 are both parallel to the plane formed by the direction D1 and the direction D2. The optical axis of the first compensation film CP1A may be at a 45-degree angle with the direction D1, and the optical axis of the second compensation film CP2 may be at a −45-degree angle with the direction D1. Furthermore, the second compensation film CP2 may also be an A-type compensation film.

The first compensation film CP1A and the second compensation film CP2 may be single-layer films or multi-layer films. The Rth of the first compensation film CP1A and the second compensation film CP2 may be adjusted and changed by material selection or thickness (such as a thickness TCP1A or a thickness TCP2) control, thereby reducing the difference in transmittance and improving the viewing experience of the wearer. In some embodiments, the total Rth of the first compensation film CP1A and the second compensation film CP2 is between 125 nm and 250 nm, but not limited thereto.

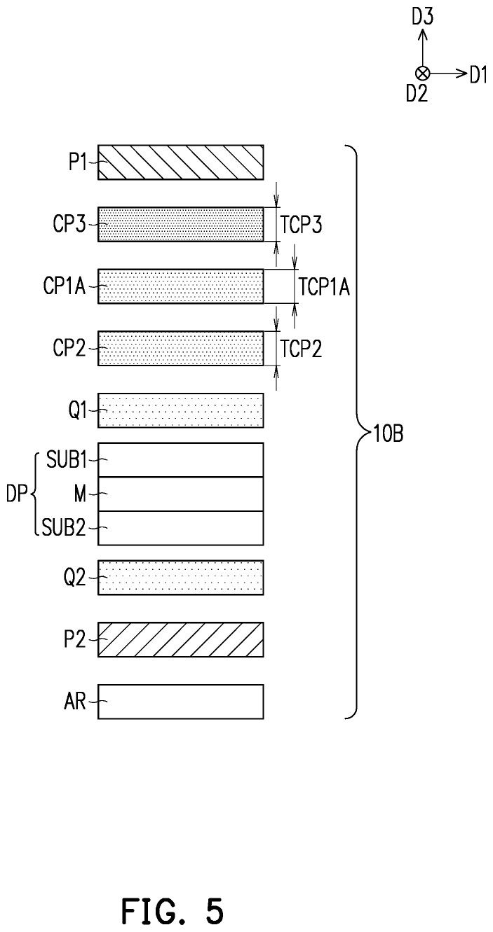

Referring to FIG. 5, the main differences between a dimming module 10B and the dimming module 10A of FIG. 4 are described as follows. The dimming module 10B further includes a third compensation film CP3 disposed between the first polarizing film P1 and the panel CP, and the total Rth of the first compensation film CP1A, the second compensation film CP2, and the third compensation film CP3 is between 125 nm and 250 nm, but not limited thereto. The third compensation film CP3, for example, is a C-type compensation film. In addition, the third compensation film CP3 may be a single-layer film or a multi-layer film. The Rth of the first compensation film CP1A, the second compensation film CP2, and the third compensation film CP3 may be adjusted and changed by material selection or thickness (such as the thickness TCP1A, the thickness TCP2, or a thickness TCP3) control, thereby reducing the difference in transmittance and improving the viewing experience of the wearer.

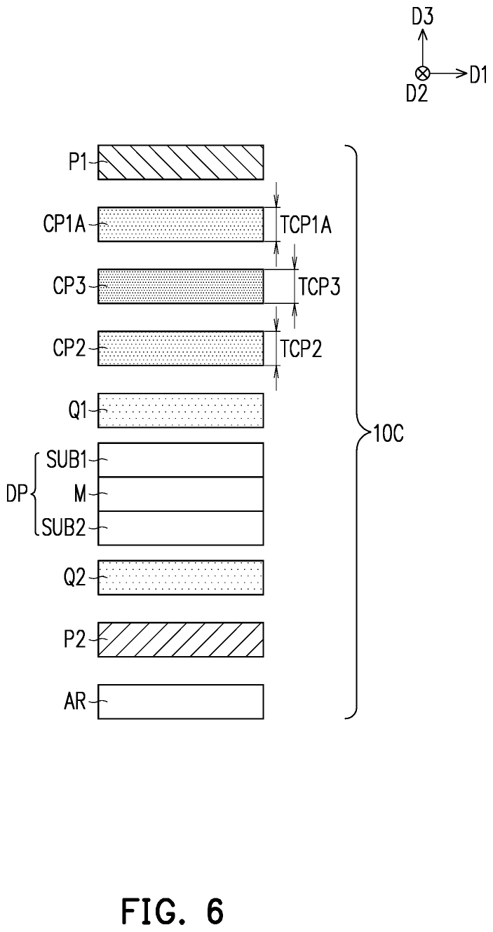

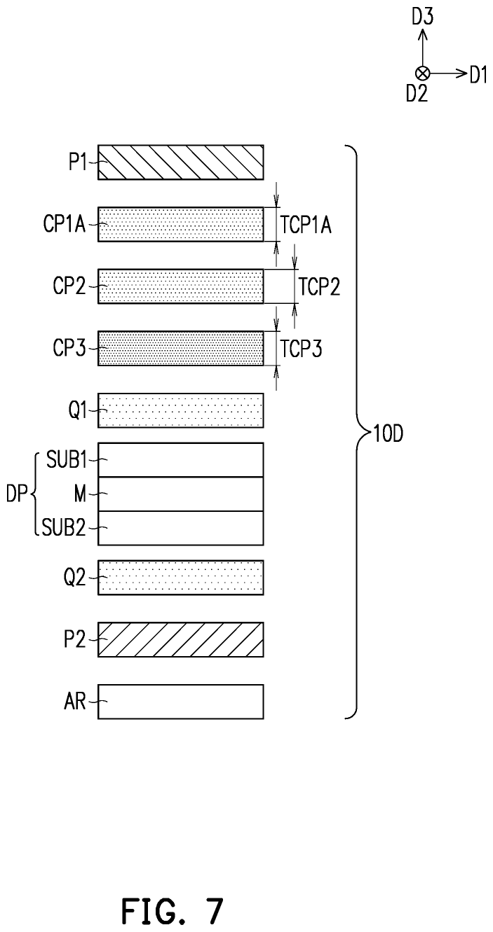

The first compensation film CP1A, the second compensation film CP2, and the third compensation film CP3 are stacked between the first polarizing film P1 and the panel CP. In some embodiments, as shown in the dimming module 10B of FIG. 5, the first compensation film CP1A may be located between the second compensation film CP2 and the third compensation film CP3, the second compensation film CP2 may be located between the first compensation film CP1A and the panel CP, and the third compensation film CP3 may be located between the first polarizing film P1 and the first compensation film CP1A. In other embodiments, as shown in a dimming module 10C of FIG. 6, the third compensation film CP3 may be located between the first compensation film CP1A and the second compensation film CP2, the second compensation film CP2 may be located between the third compensation film CP3 and the panel CP, and the first compensation film CP1A may be located between the first polarizing film P1 and the third compensation film CP3. In yet other embodiments, as shown in a dimming module 10D of FIG. 7, the second compensation film CP2 may be located between the first compensation film CP1A and the third compensation film CP3, the third compensation film CP3 may be located between the second compensation film CP2 and the panel CP, and the first compensation film CP1A may be located between the first polarizing film P1 and the second compensation film CP2. In other implementations, the above-mentioned first compensation film CP1A, second compensation film CP2, and third compensation film CP3 may also be disposed between the second polarizing film P2 and the panel DP, but the disclosure is not limited thereto.

In summary, in the embodiments of the disclosure, by reducing the difference in transmittance of light rays with different incident angles, such as satisfying [(T1-T2)/T1]*100%<50%, such a way facilitates the enhancement of the viewing experience of the wearer of the head mounted electronic device.

The above various embodiments are merely for illustrating the technical solutions of the disclosure, and not for limiting them; although the disclosure has been described in detail with reference to the foregoing embodiments, those of ordinary skill in the art should understand that: they may still make modifications to the technical solutions described in the foregoing various embodiments, or perform equivalent replacements for some or all of the technical features; and these modifications or replacements do not cause the essence of the corresponding technical solutions to deviate from the scope of the technical solutions of the various embodiments of the disclosure.

Although the embodiments and their advantages of the disclosure have been disclosed as above, it should be understood that those of ordinary skill in the art may make variations, substitutions, and modifications without departing from the spirit and the scope of the disclosure, and the features between the various embodiments may be arbitrarily mixed and replaced to form other new embodiments. In addition, the scope of protection of the disclosure is not limited to the processes, machinery, manufacture, material compositions, devices, methods, and steps described in the specific embodiments in the specification. Those of ordinary skill in the art may understand, from the content disclosed in the disclosure, the processes, machinery, manufacture, material compositions, devices, methods, and steps developed now or in the future, which may be used according to the disclosure as long as substantially the same functions may be performed or substantially the same results may be obtained in the embodiments described herein. Therefore, the scope of protection of the disclosure includes the above-mentioned processes, machinery, manufacture, material compositions, devices, methods, and steps. Furthermore, each claim constitutes an individual embodiment, and the scope of protection of the disclosure also includes the combinations of various claims and embodiments. The scope of protection of the disclosure shall be subject to those defined by the attached claims.

What is claimed is:

1. A head mounted electronic device, comprising:
a dimming module, having a normal direction, wherein the dimming module has a first transmittance T1 in the normal direction and a second transmittance T2 in an oblique direction, an included angle between the oblique direction and the normal direction is 60 degrees, and the head mounted electronic device satisfies: [(T1-T2)/T1]*100%<50%.

2. The head mounted electronic device according to claim 1, wherein the dimming module comprises a first polarizing film, a second polarizing film, a panel disposed between the first polarizing film and the second polarizing film, and a first compensation film disposed between the first polarizing film and the panel.

3. The head mounted electronic device according to claim 2, wherein phase retardation of the thickness of the first compensation film is between 125 nanometers (nm) and 250 nm.

4. The head mounted electronic device according to claim 2, wherein the first compensation film is a C-type compensation film.

5. The head mounted electronic device according to claim 4, wherein the dimming module further comprises a first quarter-wave plate disposed between the first compensation film and the panel, and a second quarter-wave plate disposed between the panel and the second polarizing film.

6. The head mounted electronic device according to claim 5, wherein the first quarter-wave plate and the second quarter-wave plate have mutually perpendicular optical axes.

7. The head mounted electronic device according to claim 5, wherein the dimming module further comprises an anti-reflection film, and the second polarizing film is disposed between the anti-reflection film and the second quarter-wave plate.

8. The head mounted electronic device according to claim 2, wherein the first compensation film is an A-type compensation film.

9. The head mounted electronic device according to claim 8, wherein the dimming module further comprises a second compensation film disposed between the first polarizing film and the panel, and the first compensation film and the second compensation film have mutually perpendicular optical axes.

10. The head mounted electronic device according to claim 9, wherein the second compensation film is an A-type compensation film.

11. The head mounted electronic device according to claim 10, wherein total phase retardation of the thickness of the first compensation film and the second compensation film is between 125 nm and 250 nm.

12. The head mounted electronic device according to claim 10, wherein the dimming module further comprises a first quarter-wave plate disposed between the second compensation film and the panel, and a second quarter-wave plate disposed between the panel and the second polarizing film.

13. The head mounted electronic device according to claim 12, wherein the first quarter-wave plate and the second quarter-wave plate have mutually perpendicular optical axes.

14. The head mounted electronic device according to claim 12, wherein the dimming module further comprises an anti-reflection film, and the second polarizing film is disposed between the anti-reflection film and the second quarter-wave plate.

15. The head mounted electronic device according to claim 10, wherein the dimming module further comprises a third compensation film disposed between the first polarizing film and the panel, and total phase retardation of the thickness of the first compensation film, the second compensation film, and the third compensation film is between 125 nm and 250 nm.

16. The head mounted electronic device according to claim 9, wherein the third compensation film is a C-type compensation film.

17. The head mounted electronic device according to claim 16, wherein the dimming module further comprises a first quarter-wave plate disposed between the second compensation film and the panel, and a second quarter-wave plate disposed between the panel and the second polarizing film.

18. The head mounted electronic device according to claim 17, wherein the first quarter-wave plate and the second quarter-wave plate have mutually perpendicular optical axes.

19. The head mounted electronic device according to claim 17, wherein the dimming module further comprises an anti-reflection film, and the second polarizing film is disposed between the anti-reflection film and the second quarter-wave plate.

20. The head mounted electronic device according to claim 1, wherein the first polarizing film and the second polarizing film have mutually perpendicular transmission axes.
